(19) United States
(12) Patent Application Publication
(10) Pub. No.: US 2002/0197025 A1
(43) Pub. Date: Dec. 26, 2002

(54) Photonic device packaging method and apparatus

(76) Inventors: Vladimir Vaganov, Los Gatos, CA (US); Sebastiaan In't Hout, San Jose, CA (US)

Correspondence Address: PATRICK REILLY MEGASENSE, 1215 BORDEAUX DRIVE, SUNNY VALE, CA, 94089, US

(21) Appl. No.: 10/174,724

(22) Filed: Jun. 19, 2002

Related U.S. Application Data
(60) Provisional application No. 60/301,160, filed on Jun. 25, 2001.

(51) Int. Cl. G02B 6/42

(52) U.S. Cl. 385/92; 385/88

(57) ABSTRACT

A photonic device package, the assembly and manufacturing methods thereof are provided. The package may be mounted to a substrate such as a PC board in a novel and inventive technique that allows several orientations, whereby a system designer has an increased flexibility in designing a module or system that includes a photonic device. The photonic device package is designed to be fabricated, handled, manufactured and tested by methods that take advantage of semiconductor industry standards.

### RELATED APPLICATIONS

This application claims priority of earlier filed U.S. Provisional Application No. 60/301,160 filed on June 25, 2001, and fully incorporates the material herein.

### BACKGROUND OF THE INVENTION

The present invention relates to the methods of design and manufacturing of optical devices and optical device packages. More particularly, the present invention provides designs useful in the mass fabrication and use of photonic device packages.

### FIELD OF THE INVENTION

The use of optical devices is rapidly growing in the art of electronic systems design. The inclusion of microelectromechanical systems (MEMS) optical switches, as one example, in optical signal management and control systems is common in the art of telecommunications system engineering. Continued improvements in the manufacturing of optical devices, and ongoing reductions in the cost of integrating optical devices into electronic systems continues to reduce the expense of products that rely upon optical signal communications technologies.

Conventional optical devices are typically not designed or sized to correspond to a particular industry standard. In contrast, the semiconductor industry has developed standards and practices which apply to almost every aspect of manufacturing, process, fabrication, assembly, packaging, equipment, and testing. Incorporating such standards and practices has greatly contributed to the dramatic cost reductions seen in this industry. Standards have also been of tremendous benefit to system designers who require custom components. The incorporation of these custom components into a system is greatly simplified by having them meet “off the shelf” specifications for mounting, electrical contacts, and orientation. Such standards also reduce the need for specialized equipment for the manufacture of devices and incorporation into electronic systems. Unfortunately, optical devices constitute a relatively new technology, and thus specific applications in this field often require vastly different configurations and designs. These custom requirements obviously play a key role in limiting the economy of optical devices. For example, higher equipment and support prices of optically based telecommunications equipment negatively affect the rate at which the telecommunications industry implements and expands superior, optical transmission systems.

The current art of optical device packages is constrained by not having such “off the shelf” compatibility. Optical device packages are presently custom designed for each application with specific optical pathways and electrical contacts for individual orientations and applications of a device, thus each new design generally requires a new package. Such a system does not allow a system designer flexibility in the layout and design of an overall system. When an optical device is contained within a specific package that must be mounted and positioned with a specific orientation, the overall system must be built around this constraint. It would thus be beneficial if a system designer had an optical device mounted in a package that could be orientated according to the system designer's preference. Such an optical device package would then have the flexibility to be aligned with a system according to the needs of the overall design, rather than determining them.

In U.S. Pat. No. 6,384,473 issued to Peterson, et al. a microelectronic device package with an integral window comprised in a first substrate is described. The package is designed to incorporate an optical device such as a semiconductor chip, a CCD chip, a CMOS chip, a VCSEL chip, a laser diode, a MEMS device, or an integrated MEMS device. The integral window is incorporated to provide an optical pathway to optical devices comprised within. A lid is also provided to seal the package from contaminants. A number of internal and external electrical bond pads are also provided such that the optical device may be controlled from the exterior of the package. Peterson, et al. discuss mounting the optical device to a second substrate, planar to the first substrate comprising the window. A constraint of this invention is inherent to the planar nature of this design. The positioning of the window and associated external electrical contacts limit flexibility of incorporating this device within a system. The device contained within the package must be orientated specifically to align with the optically transparent window, which is fixed. Provisions are not given for positioning the window on another of the external sides of the package, nor do the electrical contacts allow for much flexibility in orientating the package on an external mounting substrate.

Makiuchi, et al. discusses an alternate optical device package in U.S. Pat. No. 5,436,997. This patent discloses an optical device package having a substrate and an opening for accepting an optical device. The optical device is to be inserted through either the open top or bottom, which are then sealed with lids. A means for coupling the enclosed device with an optical fiber is provided through the sidewall of the package. Again, similar to the previous example, this invention is limited by the orientation and position of the external optical interface. The optical pathway to the device is set through a predetermined side of the package. No consideration is made for providing an alternate means or locations for accessing the enclosed optical device. Further, the electrical leads passing through the sides of the package further limit the final orientation and mounting of the complete package on a mounting substrate such as a circuit board.

U.S. Pat. Nos. 6,164,837 to Haake, et al., 6,242,694 to Muraki, 6,280,102 to Go, 6,364,542 to Deane, et al., and many others further illustrate the custom approach to building optical device packages. Each comprise a different variation, demonstrating specific optical pathways, specific configurations, and specific electrical contact locations to mount the package according to a specific need. Unfortunately, none demonstrate a more universal configuration to meet a range of applications. None fully take advantage of the lessons learned in the semiconductor industry and incorporate standards that have long proven successful in another field.

There is, therefore, a long felt need in the art of optical device assembly, manufacture and design to provide an optical device package with configuration options that provide for flexibility in mounting, orientation, and integration into a system design. Further, such an optical device package would greatly benefit from adopting compliance or partial compliance with established semiconductor industry device and equipment standards.

### OBJECTS OF THE INVENTION

Accordingly, it is a primary objective of the present invention to provide a photonic device package for use with photonic components, which overcomes prior art limitations regarding mounting, orientation, and alignment of the device package on a system substrate such as a printed circuit board.

It is a further object of the present invention to provide a photonic device package generally having a box structure with six exterior sides. It is yet a further object of the present invention to provide a photonic device package that can be mechanically and electrically mounted to a system substrate by any of at least two sides. It is yet another further object of the present invention to provide a photonic device package that can be mechanically and electrically mounted to a system substrate by any of six exterior sides.

It is another object of the present invention to provide a photonic device package with an optical pathway from the exterior of the package to a cavity within the package. Additionally, it is an object of the present invention that the optical pathway may be varied in location and may contain a transparent optical medium.

It is another further object of the present invention to provide internal and external electrical contacts with corresponding electrically conductive pathways to conduct electrical signals from the exterior of the photonic device package to the interior of the device package.

It is a further object of the present invention that a photonic device, or combination of photonic and non-photonic devices, may be contained within a cavity of a photonic device package. Such devices may be controllable via electrical or optical pathways in the body of the package.

It is another object of the present invention to provide a protruding sleeve on the exterior of the photonic device package which may align and support the attachment of auxiliary optical components.

It is further alternate object of the present invention to provide a photonic device package attached to an optical component such as a fiber or fiber bundle, whereby a system designer may select the attachment orientation of the device to a structure, such as a printed circuit board, and thereby affect the orientation and path of the fiber or the fiber bundle in relationship to the structure.

It is a final object of the present invention to provide a photonic device package for use with optical components that conforms to established manufacturing, processing, mounting, assembly, materials, and testing standards of the semiconductor Industry.

### SUMMARY OF THE INVENTION

According to the present invention, a method for manufacturing a photonic device package is provided. The photonic device package, or invented device, may be mechanically mounted to a substrate, such as a printed circuit board, by any one of at least two exterior sides. The invention may be further mechanically and electrically mounted to a substrate by any of six exterior sides. In each orientation it shall maintain an optical pathway to an enclosed photonic device.

A preferred embodiment of the invention includes an optical integrated circuit (OIC) die, a package, and a lid. The package has an internal cavity to accept the OIC die. The package and the lid partially or fully enclose and protect the OIC die. The lid seats into and is attached to the package. The OIC die may be wire bonded to wire bond pads located within the internal cavity of the package. The wire bond pads are connected via electrically conductive pathways to solder pads. The solder pads are located on an outside surface of certain or all sides of the package.

The package has a first side, second side, third side, fourth side, top side, and bottom side. The bottom and top sides are substantially flat and parallel to each other. The first and third sides (solder pad sides) are substantially flat and parallel to each other. The second and fourth sides (blank sides) are substantially flat and parallel to each other. The two solder pad sides are substantially and mutually orthogonal to (1) the two blank sides and to (2) the top side and the bottom side. A first plurality of wire bond pads are located inside the package and connect a first plurality of wire bonds from the IC die and a first plurality of traces. The first plurality of traces passes through the package and makes contact with a first plurality of solder pads. The solder pads are located on the outside of the package and run from the bottom side, wholly over the first solder pad side and onto the top side. Electrical contact may be made between the OIC die and the PC board by attaching the package to the PC board along the bottom side, the first solder pad side, the second solder pad side, or along the top side.

In an alternate preferred embodiment the bottom side shall contain an optical pathway to allow an optical signal to be incident on the photonic device contained within the package. A fiber, fiber bundle, or similar optical medium is attached to a protruding sleeve centered about the optical pathway to facilitate the optical signal. Certain alternate preferred embodiments of the present invention further comprise additional solder pad sides, such as on the second and fourth sides, and optionally blank sides that lack solder pad features, whereby some or all sides of the package may establish an electrical connection with the OIC die and an auxiliary device, such as a PC board.

In the preferred embodiment a second plurality of solder pads are electrically connected with a second set of traces, where the traces run through the package and connect with a second plurality of wire bond pads. The second plurality of wire bond pads are located within the package and are wire bonded to a second plurality of wire bonds leading to the OIC die. The second solder pad side of the preferred embodiment may be mounted onto the PC board whereby the second plurality of solder pads are electrically connected to the PC board along the second pad side. Alternately, the package may be mounted to the PC board in electrical contact with the first plurality of solder pads, leaving the second plurality of solder pads available for access by testing equipment. Because of the flexible design of the invention, the invention may be attached to a device such as a PC board in various alternate orientations. The preferred embodiment may alternatively be mounted to the PC board along either blank side whereby the first and second solder pad pluralities do not electrically connect with the PC board but are exposed and available for connection by suitable connection techniques and elements known in the art, for example with flexible substrates. The described embodiment may be further mounted with either top side or bottom side parallel to the mounting substrate, providing that provisions are made to maintain the optical pathway to the photonic device.

The invented device is designed and sized in conformance with one or more standard semiconductor industry materials, sizing and design standards such that certain preferred embodiments may be formed, fabricated assembled, wire bonded, packaged, tested and attached to the PC board by and of certain semiconductor industry standard materials, equipment and methods. Various preferred embodiments of the package may comprise suitable plastic, metallo-ceramic, or metal-glass, or other suitable materials, known in the art.

Certain alternate preferred embodiments of the method of the present invention can optionally enable the assembly of an optical device that may be assembled with clean room compatible equipment.

The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which:

FIG. 1 depicts an assembly drawing of the present invention incorporating auxiliary optical components.

FIG. 2A-E shows five profile views of the present invention.

FIG. 3A-B are cross sectional views of alternate preferred embodiments of the present invention.

FIG. 4A-F illustrate alternate mounting orientations of the present invention.

FIG. 5 is a manufacturing flow chart describing the steps and progress of manufacturing the preferred embodiments of the present invention.

### DETAILED DESCRIPTION OF THE PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result.

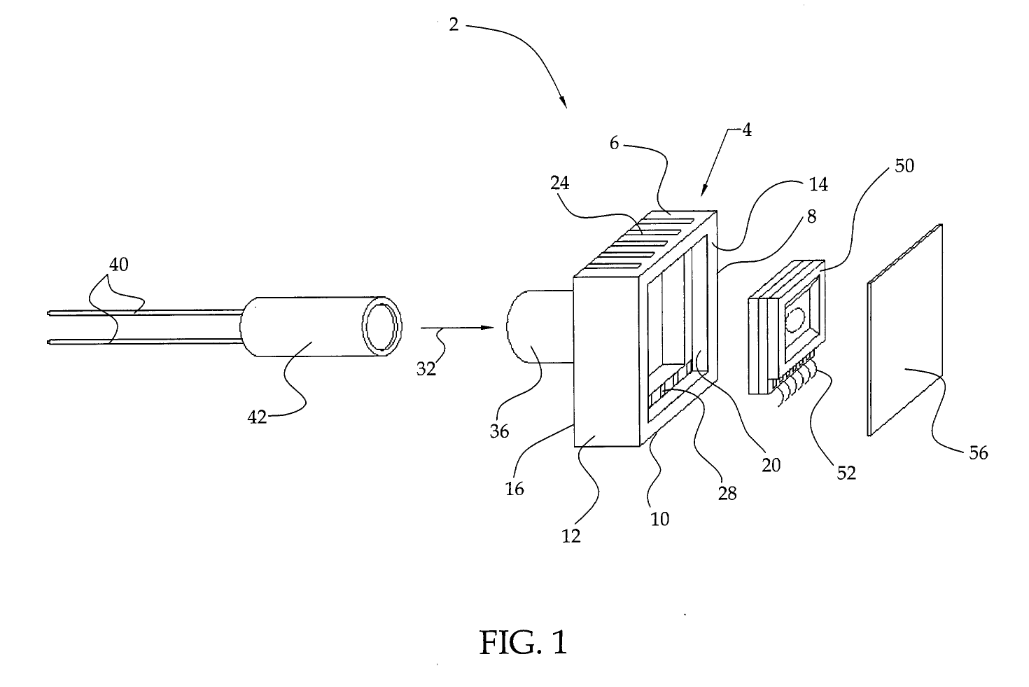

FIG. 1 is intended to provide an illustrative view of the present invention. FIG. 1 further incorporates auxiliary components including an optical device, optical waveguide, and an optical conditioning device. In a preferred embodiment of the invention, photonic device package 2 comprises a body 4, having an exterior defined by a first side 6, second side 8, third side 10, fourth side 12, top side 14 and bottom side 16. The exterior sides of body 4 substantially form a box structure. In this particular preferred embodiment of photonic device package 2, recessed cavity 20 protrudes into body 4 via top side 14. External electrical contacts 24 on the exterior of body 4 are located along first side 6. Electrical contacts 28 are within recessed cavity 20 of body 4. Although not shown in FIG. 1, one skilled in the art will recognize that external electrical contacts 24 may be connected via electrically conductive pathways to electrical contacts 28 located within recessed cavity 20. Methods for providing such electrically conductive pathways in device packages are well known in the semiconductor industry. It would thus be beneficial to apply such standard methods from the semiconductor industry to this photonic device package. Photonic package 2 also comprises an aperture (not shown) providing optical pathway 32 into recessed cavity 20. Protruding sleeve 36 is optionally shown extending outwardly from bottom side 16. Protruding sleeve 36 is centered about the aperture, such that the annulus (not shown) of protruding sleeve 36 maintains optical pathway 32 into recessed cavity 20. Protruding sleeve 36 may also be used as a scaffold to support or align auxiliary optical components. Optical fibers 40 and collimator 42 are shown as example auxiliary optical components. Such auxiliary optical components may include individual optical fibers, optical fiber bundles, waveguides, planar waveguides, collimators, lenses, filters, polarizers, and dielectric films as determined by the system designer. Optical fibers 40 are attached to collimator 42. Collimator 42 is seated into the annulus of protruding sleeve 36. Collimator 42 may be further attached to photonic device package 2 by means such as soldering, welding, adhesives, epoxies, friction fit, or other suitable means known in the art. FIG. 1 further illustrates photonic device 50 for insertion within recessed cavity 20 of photonic device package 2. On insertion of photonic device 50, lid 56 is seated to top side 14 to at least partially cover and seal recessed cavity 20. Body 4 and lid 56 may also be designed to seat lid 56 at least partially within recessed cavity 20. Such a design may include a ledge (not shown) within recessed cavity 20 to which lid 56 would be attached. Photonic device 50 is further attached to electrical contacts 28 by standard methods known in the semiconductor industry. A sample attachment method is shown using wire bonds 52. One skilled in the art may select a photonic device such as an optical integrated circuit die, optical device, micro-optical device, microelectromechanical device, laser, VCSEL, array, or photodiode to be positioned within such a photonic device package. Additionally, a combination of devices may be desired. Such additional devices may include both photonic and non-photonic devices, such as integrated circuit dies.

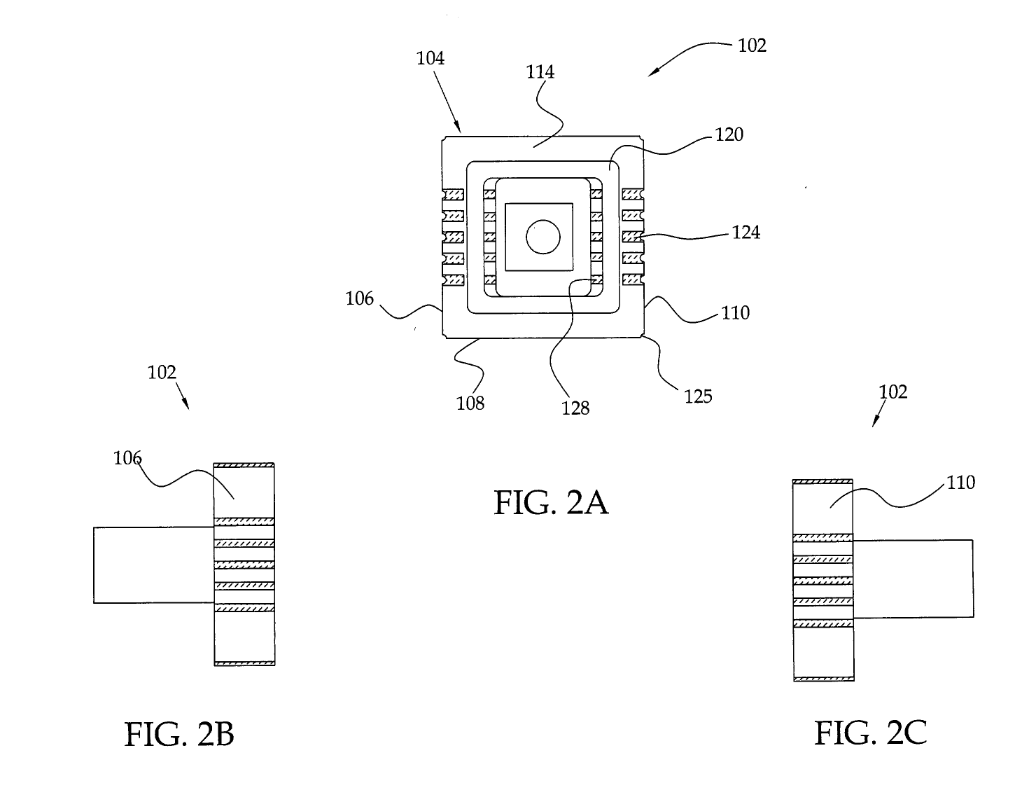

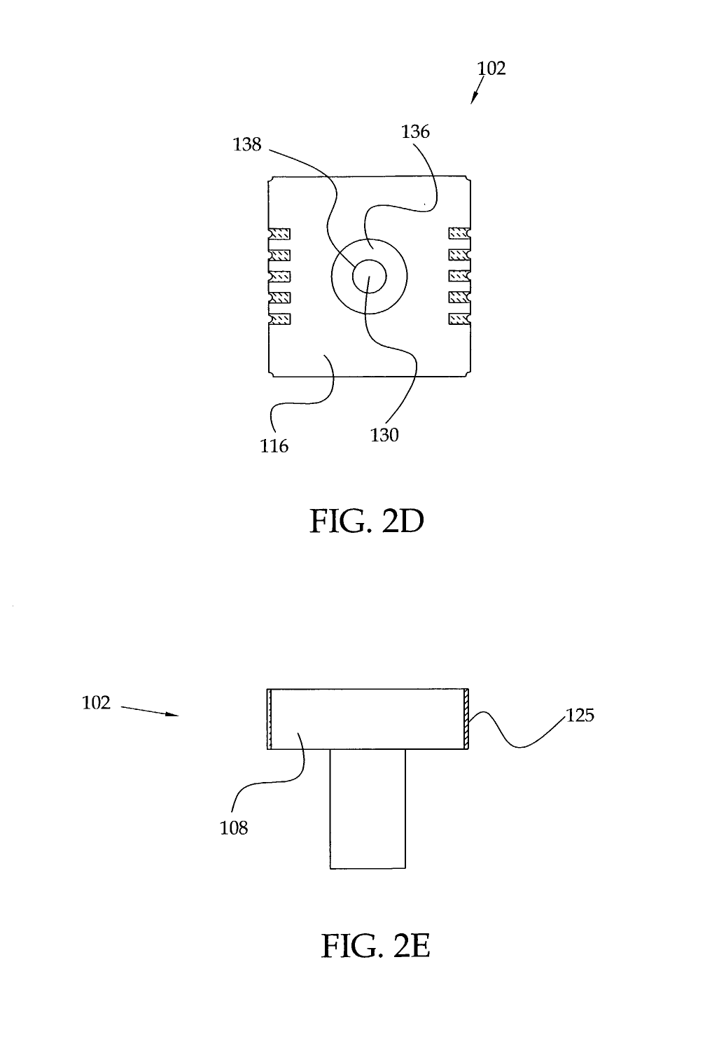

FIG. 2A-E illustrate an alternate preferred embodiment of the present invention. A photonic device package is displayed in five profile views. FIG. 2A provides a profile view of photonic device package 102 from top side 114. Body 104 has recessed cavity 120 protruding inward from top side 114. A plurality of external electrical contacts 124 located on the perimeter of top side 114, run along first side 106 and third side 110 respectively (as shown in FIG. 2B and FIG. 2C), concluding about the perimeter of bottom side 116 (as shown in FIG. 2D). A second plurality of external electrical contacts 125 run along the intersection of first side 106 and second side 108, second side 108 and third side 110, third side 110 and fourth side 112, and fourth side 112 and first side 106. Plurality of electrical contacts 128 are located within recessed cavity 120, and though not shown, are connected via an electrically conductive pathway to plurality of external electrical contacts 124 and 125. Plurality of electrical contacts 128 may be selected to be wire bond pads, and plurality of external electrical contacts 124, 125 may be selected to be solder pads. One skilled in the art will recognize that additional electrical contact mediums may also be utilized, such as conductive epoxy. FIG. 2D clearly shows aperture 130 through bottom side 116. Protruding sleeve 136 is also illustrated extending outwardly from bottom side 116, with annulus 138 maintaining optical pathway 130 to the recessed cavity. FIG. 2E displays a profile view of photonic device package 102 from second side 108. Second side 108 is displayed void of external electrical contacts, without the plurality of external electrical contacts 125 located along the edges where second side 108 intersects corresponding first and third sides. It is clear from FIG. 2A-E that the position, location, and number of electrical contacts chosen for plurality of external electrical contacts 124, 125 and plurality of electrical contacts 128 may be determined to satisfy alternate system designs. Thus it is an alternate further embodiment of the present invention that a plurality of external electrical contacts may be positioned on any, some, or all of the external sides of the body of the photonic device package. A system designer may also determine it advantageous to have the protruding sleeve act as an external electrical contact such as a ground. Thus protruding sleeve 136 may be optionally connected via an electrically conductive pathway to plurality of external electrical contacts 124, external electrical contacts 125, and/or electrical contacts 128. One skilled in the art will recognize that the multiple configurations attained by selectively determining the location and paths of external electrical contacts provides substantial flexibility in how such a photonic device package may be attached to, orientated, and aligned on a mounting substrate. To extend this flexibility, a further embodiment is set forth wherein the aperture need not be confined to the bottom side. Because of the flexibility of the photonic package design, the aperture may be positioned through any external side (or sides) of the body as long at it maintains an optical pathway to the recessed cavity. By this definition the recessed cavity itself may be determined to be an aperture when not completely sealed by lid. It will also be shown that the lid itself may comprise an aperture and thus further extend the application of the present invention. The optional configurations associated with such a flexible photonic package design are indeed numerous.

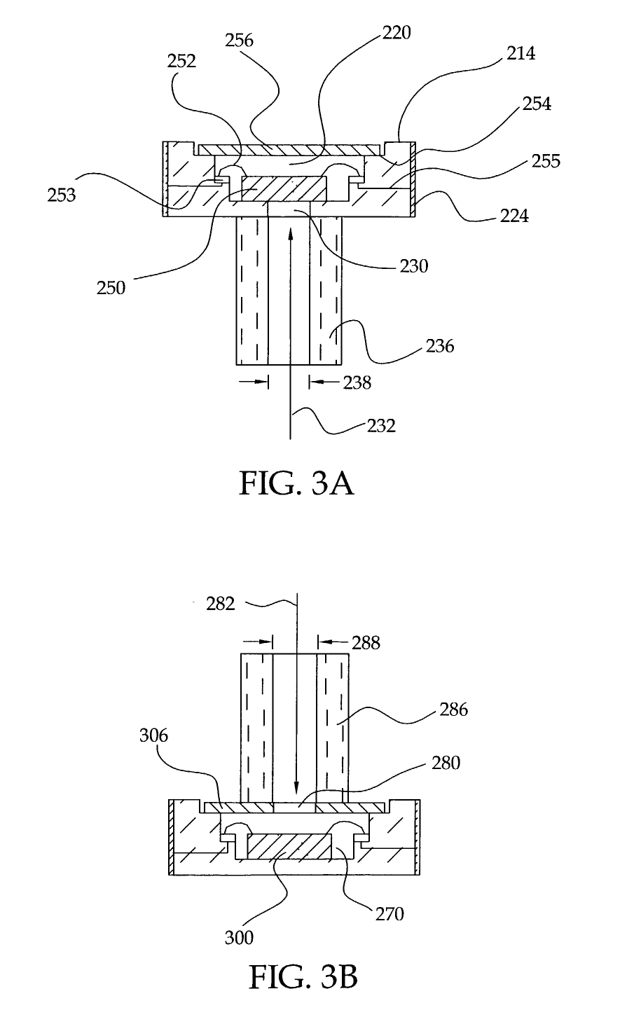

FIG. 3A and FIG. 3B illustrate a further embodiment of the present invention. FIG. 3A is a cross section through the normal axis of aperture 230 of one configuration of the present invention. Recessed cavity 220 extends into body 204 from top side 214. Lid 256 is inset from top side 214 along ledge 254. Photonic device 250 is contained within recessed cavity 220, connected via wire bonds 253 to wire bond pads 253. Electrically conductive pathways 255 connect wire bond pads 253 with solder pads 224. Aperture 230 creates an optical pathway 232 to photonic device 250 within recessed cavity 220. Protruding sleeve 236 extends outwardly from bottom side 216, with annulus 230 centered about aperture 230. Annulus 238 of protruding sleeve 236 further provides optical pathway 232, through aperture 230, to photonic device 250 within recessed cavity 220. As discussed with respect to FIG. 2A-E, it is desirable to have flexibility in choosing the position of the aperture providing an optical pathway to the recessed cavity. Thus FIG. 3B illustrates a further preferred embodiment of the present invention wherein aperture 280 provides an optical pathway 282 to photonic device 300 in recessed cavity 270 through lid 306. Protruding sleeve 286 extends outwardly from lid 306, with annulus 288 centered about aperture 280 in lid 306. Thus additional flexibility is awarded to the present invention. An optical pathway may thus be directed to a photonic device within the recessed cavity of the photonic device package via any exterior side, including those covered by lids. This is truly a beneficial advantage over the prior art. Thus in yet a further preferred embodiment of the present invention, multiple apertures are present to provide multiple optical pathways to the interior of the photonic device package. Such a photonic device package may have a photonic device mounted internally with any orientation, and still maintain at least one optical pathway to provide an optical interface with the enclosed device. Such apertures may be through external sides, lids, and recesses, as well may have protruding sleeves centered about them for supporting auxiliary optical components.

In a yet another further preferred embodiment of the present invention, the recessed cavity within the body of the photonic device package is replaced by an internal cavity encapsulated within the body. One skilled in the art will be familiar with such a package known and used in the semiconductor Industry. Processes are available to encapsulate integrated circuit dies within a device package. A similar process would be beneficial to the photonic device package of the present invention as it would reduce the potential for contamination and eliminate the processing step of applying a lid to cover the recessed cavity. A void aperture is maintained in the body of the photonic package to provide an optical pathway to the enclosed photonic device. Alternately, the aperture may comprise an optically transparent medium capable of maintaining such an optical pathway. One skilled in the art will recognize that a number of suitable optically transparent mediums are available such as a window, waveguide, optical fiber, optical fiber bundle, lens, collimator, filter, polarizer, and dielectric film. It is further noted that such optically transparent mediums may also be at least partially incorporated into the aperture previously discussed with respect to a photonic device package having a recessed internal cavity.

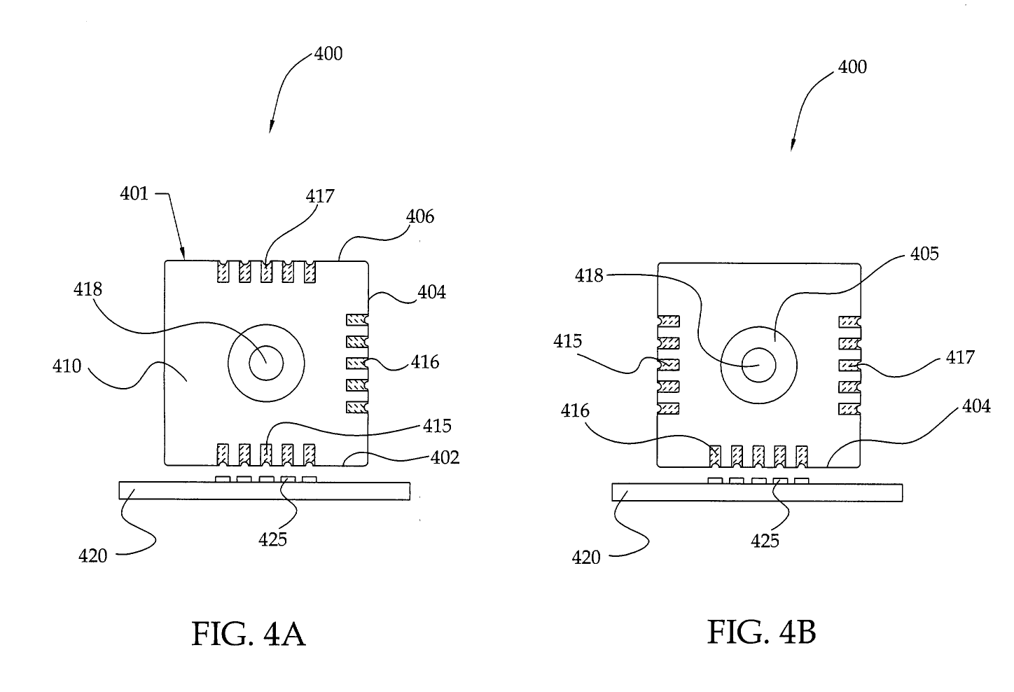

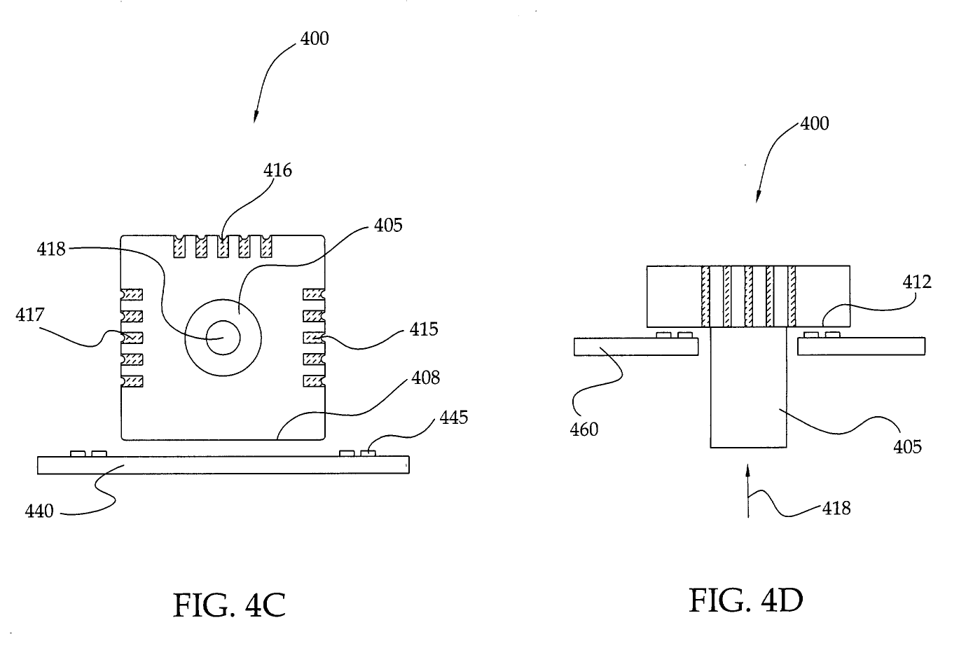

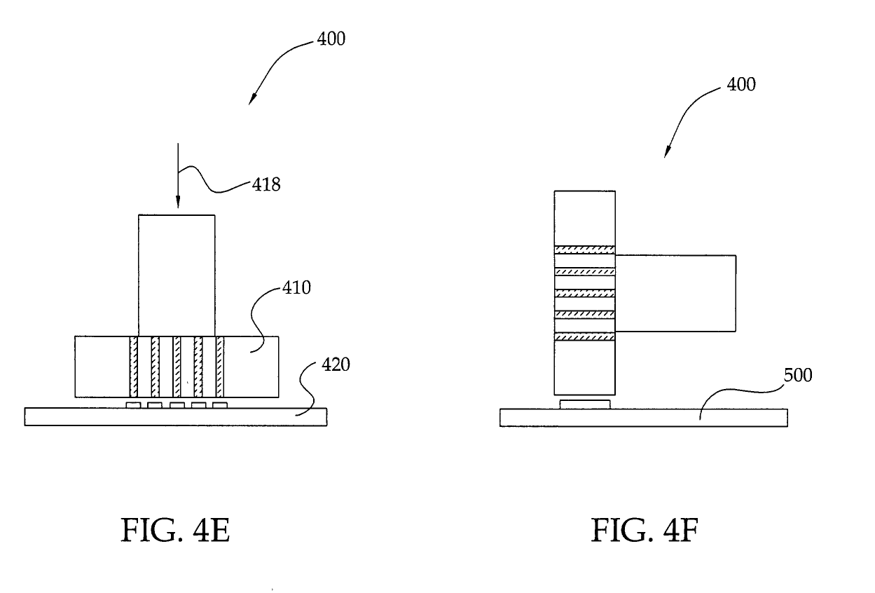

FIG. 4A-F provide illustrative examples of the flexibility in mounting and orientation of the present invention. The figures show a preferred embodiment of the present invention configured to allow for maximum system design flexibility. FIG. 4A shows photonic device package 400 having substantially planar and orthogonal sides, with first side 402 parallel to mounting substrate 420. Plurality of external electrical contacts 415, 416, and 417 are located on first side 402, second side 404, and third side 406 respectively, concluding along the perimeter of bottom side 410 and the top side (not shown) of body 401. An optical pathway 418 is maintained into the page to the photonic device packaged within. Photonic device package 400 may be mechanically mounted to mounting substrate 420. Additionally, plurality of external electrical contacts 415 may be attached to electrical contacts 425 on mounting substrate 420 by methods such as solder re-flow and wire bonding. Plurality of external electrical contacts 416 and 417 may also be attached to electrical contacts 425, be attached to an auxiliary device, used for access by testing equipment, or left unused.

FIG. 4B illustrates photonic device package 400 of FIG. 4A rotated 90 degrees about the axis of protruding sleeve 405. In this orientation, second side 404 is parallel to mounting substrate 420. This illustration further displays the flexibility of the present invention. In this alternate orientation no functionality is lost. Second side 404 may be mechanically mounted to mounting substrate 420, plurality of electrical contacts 416 may be attached to electrical contacts 420, and plurality of electrical contacts 415 and 417 remain free for alternate use. As with FIG. 4A, optical pathway 418 to the interior of photonic device package 400 is maintained.

FIG. 4C illustrates photonic device package 400 of FIG. 4B rotated 180 degrees about the axis of protruding sleeve 405. In this orientation a blank side, fourth side 408, is parallel to mounting substrate 440. Fourth side 408 may be mechanically mounted to mounting substrate 440. According to the system designer's preference, plurality of external electrical contacts 415, 416, and 417 may optionally be attached to contact pads 445 by a method such as soldering, attached to auxiliary devices, or left unused. As per FIG. 4A and FIG. 4B, optical pathway 418 to the interior of photonic device package is maintained.

FIG. 4D displays protruding sleeve 405 of photonic packaging device 400 passing through mounting substrate 460. Again, optical pathway 418 is maintained. Photonic device package 400 may be mechanically or electrically attached to mounting substrate 460 along bottom side 412.

FIG. 4E illustrates photonic packaging device 400 with top side 410 parallel to, and in proximity with, mounting substrate 420. Optical pathway 418 is maintained normal to the plane of mounting substrate 420. Photonic device package 400 may be mechanically and/or electrically attached to mounting substrate 420 along top side 410.

FIG. 4F illustrates photonic device package 400 rotated ninety degrees about the normal axis of mounting substrate 500 as compared to photonic device package 400 of FIG. 4A. Photonic device package 400 may be mechanically and/or electrically attached to mounting substrate 500. Again, even with the multitude of orientations illustrated in FIGS. 4A-4F, the photonic device package of the present invention maintains flexibility in mounting, optional electrical attachments, alignment, and preserves an optical pathway to the enclosed photonic device. A system designer may thus freely choose the specific placement and orientation of the photonic device package within a larger system.

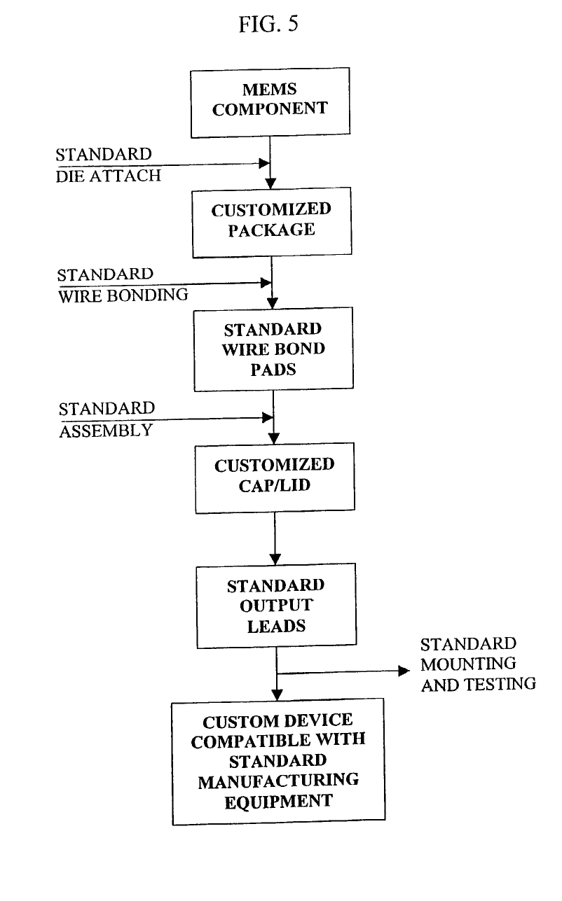

Referring now generally to the Figures and particularly to FIG. 5, a manufacturing process for the fabrication, production, assembly, wire bonding, mounting and test of preferred embodiments of the present invention is provided. The photonic device is fabricated and the photonic device package is formed. The photonic device may then be attached to the photonic device package by suitable die attach techniques and equipment known in the art. The photonic device is then wire bonded to the wire bond pads of the photonic device package using suitable standard wire bonding techniques and equipment known in the art. The lid is formed and attached to the photonic device package using suitable attachment techniques and equipment known in the art. Industry standard output leads may then be attached to the photonic device package, and the package may be mounted and tested using suitable techniques and equipment known in the art. The resulting photonic device package produced by the method of the present invention may comprise a custom package that is compatible or in compliance with industry standard manufacturing, assembly, fabrication, wire-bonding, mounting and testing techniques and equipment known in the art.

The invented device is designed and sized in conformance with one or more standard semiconductor industry materials, sizing and design standards such that the preferred embodiment may be formed, fabricated assembled, wire bonded, packaged, tested and attached to the PC board by and of certain semiconductor industry standard materials, equipment and methods. Various preferred embodiments of the package may comprise suitable plastic, metallo-ceramic, or metal-glass, or other suitable materials, known in the art.

Certain alternate preferred embodiments of the method of the present invention can optionally enable the assembly of a photonic device package that may be assembled with clean room compatible equipment.

Those skilled in the art will appreciate that various adaptations and modifications of the just-described preferred embodiments could be configured without departing from the scope and spirit of the invention. Other suitable fabrication, manufacturing, assembly, wire bonding and test techniques and methods known in the art can be applied in numerous specific modalities by one skilled in the art and in light of the description of the present invention described herein. Therefore, it is to be understood that the invention may be practiced other than as specifically described herein. The above description is intended to be illustrative, and not restrictive. Many other embodiments will be apparent to those of skill in the art upon reviewing the above description. The scope of the invention should, therefore, be determined with reference to the knowledge of one skilled in the art and in light of the disclosures presented above.

What is claimed is:

1. A photonic device package comprising;
a. A body comprising;
i. An exterior having a first side, second side, third side, fourth side, top side, and bottom side;
ii. An internal cavity;
b. At least one external electrical contact on said exterior of said body;
c. At least one aperture through said exterior of said body;
Wherein said at least one aperture shall provide an optical pathway from said exterior of said body to said internal cavity, said body shall be mechanically mountable by any of at least two of said first side, second side, third side, fourth side, top side, and bottom side to a mounting substrate such that said at least one external electrical contact shall be attachable to at least one alternate electrical contact on said mounting substrate or auxiliary electronic device.

2. The photonic device package of claim 1, wherein said first side is orthogonal to said second side, said third side is orthogonal to said fourth side, said first side and said third side are substantially parallel to each other, said second side and said fourth side are substantially parallel to each other, said top side is orthogonal to said first side, said bottom side is orthogonal to said first side, and said top side and said bottom side are substantially parallel to each other.

3. The photonic device package of claim 1, wherein said body shall be mechanically mountable to a mounting substrate by any of said top side, bottom side, first side, second side, third side, and fourth side.

4. The photonic device package of claim 1, wherein said at least one external electrical contact comprises a plurality of external electrical contacts.

5. The photonic device package of claim 4, wherein said plurality of external electrical contacts are connected via electrically conductive pathways to at least one electrical contact within said internal cavity.

6. The photonic device package of claim 1, wherein said aperture comprises a void space.

7. The photonic device package of claim 1, wherein said aperture at least partially comprises an optically transparent medium.

8. The photonic device package of claim 7, wherein said optically transparent medium is selected from the group consisting of a window, waveguide, optical fiber, optical fiber bundle, lens, collimator, filter, and dielectric film.

9. The photonic device package of claim 1, wherein a photonic device shall be substantially contained within said internal cavity.

10. The photonic device package of claim 9, wherein said photonic device shall be selected from the group consisting of an optical integrated circuit die, optical device, micro-optical device, microelectromechanical device, laser, VCSEL, array, and photodiode.

11. The photonic device package of claim 9, wherein said internal cavity shall substantially contain said photonic device and at least one additional device selected from the group consisting of an integrated circuit die, optical integrated circuit die, optical device, micro-optical device, microelectromechanical device, laser, VCSEL, array, and photodiode.

12. The photonic device package of claim 1, wherein a protruding sleeve shall extend outwardly from said exterior of said body.

13. The photonic device package of claim 12, wherein said protruding sleeve shall be centered about said at least one aperture.

14. The photonic device package of claim 13, wherein said protruding sleeve shall comprise an annulus that shall maintain an optical pathway to said at least one aperture.

15. The photonic device package of claim 12, wherein said protruding sleeve shall comprise a scaffold for mounting an optical component.

16. The photonic device package of claim 15, wherein said optical component shall be selected from the group consisting of an optical component housing, optical fiber, optical fiber bundle, waveguide, lens, collimator, filter, polarizer, and dielectric film.

17. The photonic device package of claim 1, wherein said mounting substrate comprises a printed circuit board or equivalent.

18. The photonic device package of claim 1, wherein said body is comprised of a material, or combination of materials, selected from the group consisting of ceramics, plastics, metals, glass.

19. The photonic device package of claim 1, wherein said photonic device package substantially conforms to standards applied to semiconductor device packages.

20. The photonic device package of claim 19, wherein said standards applied to semiconductor device packages are selected from the group consisting of manufacturing, processing, mounting, assembly, and testing.

21. A photonic device package comprising;
a. A body comprising;
i. An exterior having a first side, second side, third side, fourth side, top side, and bottom side;
ii. A recessed cavity within said body;
b. At least one external electrical contact on said exterior of said body;
c. At least one aperture providing an optical pathway to said recessed cavity;
Wherein said recessed cavity shall protrude into said body from at least one of said first side, second side, third side, fourth side, top side and bottom side, said body shall be mechanically mountable by any of at least two of said first side, second side, third side, fourth side, top side, and bottom side to a mounting substrate such that said at least one external electrical contact shall be attachable to at least one alternate electrical contact on said mounting substrate or auxiliary electronic device.

22. The photonic device package of claim 21, wherein said first side is orthogonal to said second side, said third side is orthogonal to said fourth side, said first side and said third side are substantially parallel to each other, said second side and said fourth side are substantially parallel to each other, said top side is orthogonal to said first side, said bottom side is orthogonal to said first side, and said top side and said bottom side are substantially parallel to each other.

23. The photonic device package of claim 21, wherein said body shall be mechanically mountable to said mounting substrate by any of said top side, bottom side, first side, second side, third side, and fourth side.

24. The device package of claim 21, wherein said recessed cavity shall be at least partially covered by a lid.

25. The device package of claim 24, wherein said lid shall further comprise said at least one aperture, providing an optical pathway to said recessed cavity.

26. The photonic device package of claim 25, wherein said at least one aperture comprises a void space.

27. The photonic device package of claim 25, wherein said at least one aperture at least partially comprises an optically transparent medium.

28. The photonic device package of claim 27, wherein said optically transparent medium is selected from the group consisting of a window, waveguide, optical fiber, optical fiber bundle, lens, collimator, filter, and dielectric film.

29. The device package of claim 25, wherein said lid shall further comprise a protruding sleeve.

30. The device package of claim 29, wherein said protruding sleeve shall be centered about said at least one aperture in said lid, providing an optical pathway to said recessed cavity.

31. The photonic device package of claim 29, wherein said protruding sleeve shall provide a scaffold for the attachment of optical components.

32. The photonic device package of claim 31, wherein said optical components shall be selected from the group consisting of at least one of an optical fiber, optical fiber bundle, waveguide, lens, collimator, filter, polarizer, dielectric film, and optical component housing.

33. The optical device package of claim 24, wherein said lid shall be connected via an electrically conductive pathway to at least one electrical contact within said recessed cavity.

34. The photonic device package of claim 21, wherein said at least one external electrical contact is connected via an electrically conductive pathway to an alternate said at least one external electrical contact on said exterior of said body.

35. The photonic device package of claim 21, wherein said at least one external electrical contact comprises a plurality of external electrical contacts.

36. The photonic device package of claim 35, wherein said plurality of external electrical contacts are located on any of at least two sides of said exterior of said body.

37. The photonic device package of claim 35, wherein said plurality of external electrical contacts are connected via electrically conductive pathways to at least one electrical contact within said recessed cavity.

38. The photonic device package of claim 37, wherein said at least one electrical contact within said recessed cavity comprises a plurality of internal electrical contacts within said recessed cavity.

39. The photonic device package of claim 21, wherein said at least one aperture comprises a void space.

40. The photonic device package of claim 21, wherein said at least one aperture at least partially comprises an optically transparent medium.

41. The photonic device package of claim 40, wherein said optically transparent medium is selected from the group consisting of a window, waveguide, optical fiber, optical fiber bundle, lens, collimator, filter, and dielectric film.

42. The photonic device package of claim 21, wherein a protruding sleeve shall extend outwardly from said exterior of said body.

43. The photonic device package of claim 42, wherein said protruding sleeve shall be centered about said at least one aperture.

44. The photonic device package of claim 42, wherein said protruding sleeve shall comprise an optical pathway to said aperture.

45. The photonic device package of claim 42, wherein said protruding sleeve shall provide a scaffold for mounting an optical component.

46. The photonic device package of claim 45, wherein said optical component shall be selected from the group consisting of an at least one of an optical component housing, optical fiber, optical fiber bundle, waveguide, lens, collimator, filter, polarizer, and dielectric film.

47. The optical device package of claim 42, wherein said protruding sleeve shall be connected via an electrical conductive pathway to at least one electrical contact within said recessed cavity.

48. The photonic device package of claim 21, wherein at least partially contained within said recessed cavity shall be a photonic device selected from the group consisting of an optical integrated circuit die, optical device, micro-optical device, microelectromechanical device, laser, VCSEL, array, and photodiode.

49. The photonic device package of claim 48, wherein at least partially contained within said recessed cavity shall be said photonic device and at least one additional device selected from the group consisting of an integrated circuit die, optical integrated circuit die, optical device, micro-optical device, microelectromechanical device, laser, VCSEL, array, and photodiode.

50. The photonic device package of claim 21, wherein said alternate electrical contact not comprised within said photonic device package is located on said mounting substrate.

51. The photonic device package of claim 21, wherein said mounting substrate comprises a printed circuit board or equivalent.

52. The photonic device package of claim 21, wherein said body is comprised of a material selected from the group consisting of ceramics, plastics, metals, glass, or some combination thereof.

53. The photonic device package of claim 21, wherein said photonic device package substantially conforms to standards applied to semiconductor device packages.

54. The photonic device package of claim 53, wherein said standards applied to semiconductor device packages are selected from the group comprising manufacturing, processing, mounting, assembly, and testing.
